(19) United States
(12) Patent Application Publication
(10) Pub. No.: US 2005/0114430 A1
(43) Pub. Date: May 26, 2005

(54) Method and apparatus for providing internet contents

(76) Inventors: Bin Zheng, Shanghai (CN); Fei Yu, Shanghai (CN)

Correspondence Address: HARNESS, DICKEY & PIERCE, P.L.C., P.O. BOX 8910, RESTON, VA, 20195, US

(21) Appl. No.: 10/970,397

(22) Filed: Oct. 22, 2004

Related U.S. Application Data
(63) Continuation-in-part of application No. 10/757,572, filed on Jan. 15, 2004.

(30) Foreign Application Priority Data
Aug. 20, 2004 (CN) 2004100582973
Jan. 17, 2003 (CN) 03114947.2

(51) Int. Cl. G06F 15/16

(52) U.S. Cl. 709/200

(57) ABSTRACT

The present invention provides a method of providing Internet contents, comprising steps of: downloading said Internet contents in a manner substantially unnoticeable to a user who browses a web page; presenting, in a container, said Internet contents to said user, after said Internet contents are completely downloaded. The present invention further provides a method of providing Internet contents, comprising steps of: inserting into a host web page of said Internet contents a tag used for creating an initially invisible container for Internet contents; downloading said Internet contents in a manner substantially unnoticeable to a user; inserting into said tag codes for displaying said Internet contents with surroundings being transparent, after said Internet contents are completely downloaded; setting said tag to be visible; and presenting said Internet contents in a container for Internet contents created using said tag.

### CROSS-REFERENCE TO RELATED APPLICATIONS

This application is a continuation-in-part patent application of U.S. application Ser. No. 10/757,572, filed on Jan. 15, 2004, which claims priority from Chinese patent application No. 03114947.2, filed on Jan. 17, 2003. This application also claims priority from Chinese patent application No. 200410058297.3, filed on Aug. 20, 2004.

### FIELD OF THE INVENTION

The present invention relates to the Internet-based contents providing system, and more particularly to a method and apparatus for producing and providing Internet contents.

### BACKGROUND OF THE INVENTION

The Internet has been widely accepted as the fourth medium. After developing for many years, the Internet has become a rival to the traditional advertising media in respect of viewers and coverage. The Internet advertisement is superior to the traditional advertising media in such areas as one-to-one marketing and interactive services. The Internet has also developed into an important medium that provides other Internet contents besides the Internet advertisement.

However, due to the bandwidth limitation and the performance of network transmission, the Internet advertisement is inferior to the television medium in respect of ways of expression that can be used in brand promotion. Most medium web sites (such as www.sina.com.cn) adopt the following ways of delivering advertisements: embedding large scale “Flash” advertisements within web pages, or displaying large scale advertisements in new popup windows. The advertisements delivered in the above ways are simultaneously downloaded in the process of loading the web pages, which no doubt prolongs the time for displaying the web pages. Normally, the size of an Internet advertisement delivered in the prior advertising system is strictly restricted to about 20K bytes. No advertisements of larger sizes are allowed. Therefore, the ways of expression of Internet advertisements delivered in the prior advertising systems are limited. As a result, it is difficult for advertisers and advertisement agents to achieve their desired creative concepts.

Most of the current Internet advertisements are displayed on the rectangular windows or banners. The very limited ways of expression and tedious styles cannot easily attract the viewers' attention. Furthermore, the forced display of advertisements in web pages could annoy the viewers.

### SUMMARY OF THE INVENTION

The technical problems to be solved by the present invention are how to provide and present large scale (for example 20K bytes or more) Internet contents such as Internet advertisements to the users, in a polite way, without affecting the users' browsing through the host web pages, and how to produce and present Internet contents in any shape with transparent surroundings.

The present invention provides a method of providing Internet contents, comprising steps of:

downloading said Internet contents in a manner substantially unnoticeable to a user who browses a web page;

presenting, in a container, said Internet contents to said user, after said Internet contents are completely downloaded.

The present invention further provides a method of providing Internet contents, comprising steps of:

inserting into a host web page of said Internet contents a tag used for creating an initially invisible container for Internet contents;

downloading said Internet contents in a manner substantially unnoticeable to a user;

inserting into said tag codes for displaying said Internet contents with surroundings being transparent, after said Internet contents are completely downloaded;

setting said tag to be visible; and

presenting said Internet contents in a container for Internet contents created using said tag.

The present invention further provides an apparatus for providing Internet contents, comprising:

means for downloading Internet contents in a manner substantially unnoticeable to a user who browses a web page;

means for presenting said Internet contents to said user in a container after said Internet contents are completely downloaded.

Since the file size of the Internet contents provided by the present invention is no longer restricted to 20K bytes, a lot of ways of expression become feasible in producing Internet contents. Thus the Internet contents delivered according to the present invention can achieve effects superior to those of traditional TV advertisements.

The Internet contents produced according to the present invention may never adopt the style of a traditional rectangular window or a banner. The Internet contents of the present invention may be represented as contents in any shape with transparent surroundings, which move on a host web page. The applicant named the Internet contents in the above novel forms as “AnyShape” contents. “AnyShape” contents can greatly attract the user's attention, which is very important to the Internet advertisements.

The Internet contents of the present invention may be carried in any container (dialog box, popup window, banner, floating window/floating layer, inline frame, etc.), and displayed at any positions, so as to provide various interactive contents and take statistics on the users' activities such as clicks.

The medium format of the Internet contents of the present invention is unlimited, which may be Flash format, AVI format, vrml (virtual reality) format, etc. The Internet contents will not be blocked by any kinds of tools for killing pop-up windows, if they are presented in dialog boxes.

The apparatus or method of providing Internet contents according to the present invention may be implemented in the web pages (also referred to as host web page) along with which the Internet contents are scheduled to be delivered. It is not necessary for a viewer to additionally install any plugins. The apparatus and method of the present invention also apply to browsers that do not support Java applet.

The Internet contents of the present invention are not limited to the Internet advertisement, and may be other kinds of Internet contents, such as on-line games, on-line contests, on-line polls, etc.

Other features and advantages of the present invention will be much clearer from the following description of the preferred embodiments, taken in conjunction with the accompanying drawings, which illustrate, by way of example, the principles of the invention.

### BRIEF DESCRIPTION OF THE DRAWINGS

FIG. 1 is a block diagram of the Internet advertising system according to one embodiment of the present invention;

FIG. 2 schematically shows the apparatus for providing Internet advertisements according to one embodiment of the present invention;

FIG. 3 is a flow chart of the method of providing Internet advertisements according to another embodiment of the present invention;

FIG. 4A to FIG. 4G show the effects of displaying an exemplified automotive Internet advertisement according to one embodiment of the present invention; and

FIG. 5 shows the effects of displaying an exemplified mobile phone Internet advertisement according to one embodiment of the present invention.

### DETAILED DESCRIPTION OF THE PREFERRED EMBODIMENTS

The embodiments of the present invention will be described in detail in the following. In each embodiment, take Internet advertisement as an example of the Internet contents. But, those skilled in the art should appreciate that the principles of the invention and even each embodiment may be used, without any modification, to produce and provide other Internet contents besides the Internet advertisement. Thus, the present invention is not limited to produce and provide the Internet contents. The present invention may also be used to produce and provide other Internet contents such as on-line games, on-line contests, on-line polls, etc.

Internet Advertising System

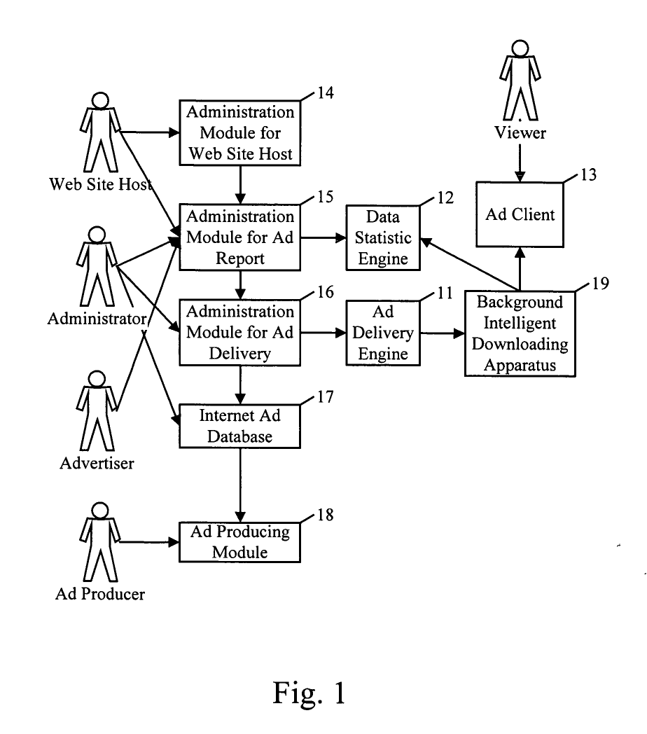

FIG. 1 is a block diagram of the Internet-based advertising system according to one embodiment of the present invention. As shown in FIG. 1, the Internet-based advertising system includes: ad delivery engine 11, data statistic engine 12, ad client 13, administration module for ad report 15, administration module for ad delivery 16, and background intelligent downloading apparatus 19.

In order to play an Internet advertisement in a certain web page, corresponding codes of the Internet advertisement should be inserted into the HTML codes of the web page (i.e. the host web page). In this way, the Internet advertisement is delivered to users along with web page. URLs (Uniform Resource Locator) of Internet advertisements are usually embedded in web pages. Ad delivery engine 11 is used to insert URLs of Internet advertisements to be delivered into host web pages. Alternatively, ad delivery engine 11 inserts Internet advertisement IDs into the host web pages, and the script languages in the web pages may translate Internet advertisement IDs into URLs of the Internet advertisements to be delivered.

Producing Internet Advertisements

Hereunder, taking “Flash” type files as an example, the process of producing an Internet advertisement according to the present invention is described.

Firstly, based on advertisement materials, “Flash” type source files (“.fla” files) are developed.

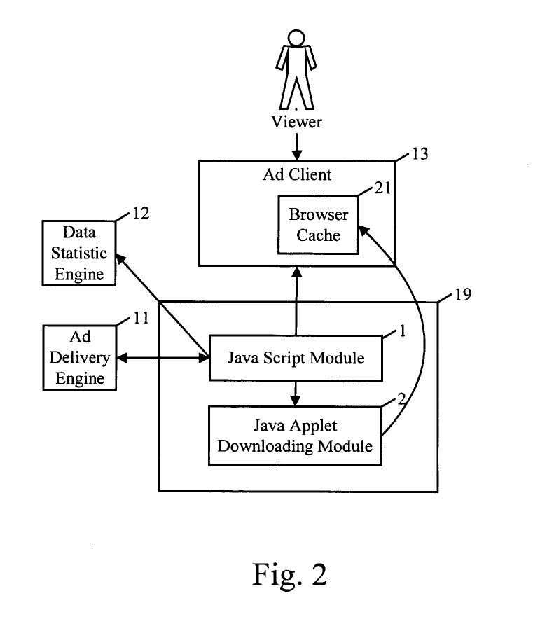

Then, advertisement play control codes and personality statistic codes are inserted in the “Flash” type source files. The advertisement play control codes are used to control the activities initiated by the user during the playing of the Internet advertisement, such as pause, continue, replay, volume control, etc. The personality statistic codes are used to record the user's activities while the user is watching the Internet advertisement, and delivering the recorded information to a JavaScript module (denoted by 1 in FIG. 2) in the host web page. The JavaScript module finally submits data to the data statistic engine 12 (denoted by 12 in FIG. 2).

The above control codes and statistic codes may be implemented as ActionScript plugins embedded in Flash (available from Macromedia Inc.) files. ActionScript is a language used in Flash and similar to JavaScript. ActionScript is used to control the play and execution of “Flash” files, and also used to generate some special effects, etc.

For example, in order to take statistics on the clicks on places (such as a certain area) of the advertiser's interest, statistic codes FSCommand(‘record_click1’) is inserted at a corresponding position in the “Flash” source file. Thus, when the certain area is clicked, the statistic codes will send corresponding messages to JavaScript module 1 in the host web page, so that data is finally submitted to data statistic engine 12.

After advertisement play control codes and personality statistic codes are inserted, the “Flash” type source file may have the structure as shown in Table 1.

TABLE 1
Advertisement Contents

Inserted Flash Plugin
1. Advertisement play control codes
2. Personality statistic codes

Finally, the “Flash” type source file (“.fla” file) is compiled (published) to “.swf” file and published.

In the “Flash” type file, two methods are generally adopted to send messages to the host web page which contains the “Flash” type file. One method is to adopt “getURL” (“javascript:<JavaScript codes visible in web page>”)” The other method is to adopt “FSCommand(<parameter>)” command.

The method adopting getURL is convenient to use. But, getURL can only call functions and variables included in the host web page. The “Flash” type file adopting this method can only be used in the corresponding web page. If such a “Flash” type file is moved into a different web page, or is played alone by a Flash player (for example, “flashplayer.exe” freely available from Macromedia Inc.), a new browser window will pop up in which the player will try to run a piece of non-existent codes and some error information will then be displayed. This is inconvenient for the users.

The method adopting FSCommand requires that JavaScript codes for receiving messages be included in host web pages. Thus the programming is burdensome, but the method is convenient to use. If there are no corresponding JavaScript codes (i.e. interface program) in host web page, web pages and player will ignore the messages sent via FSCommand. Thus, unnecessary troubles will be prevented.

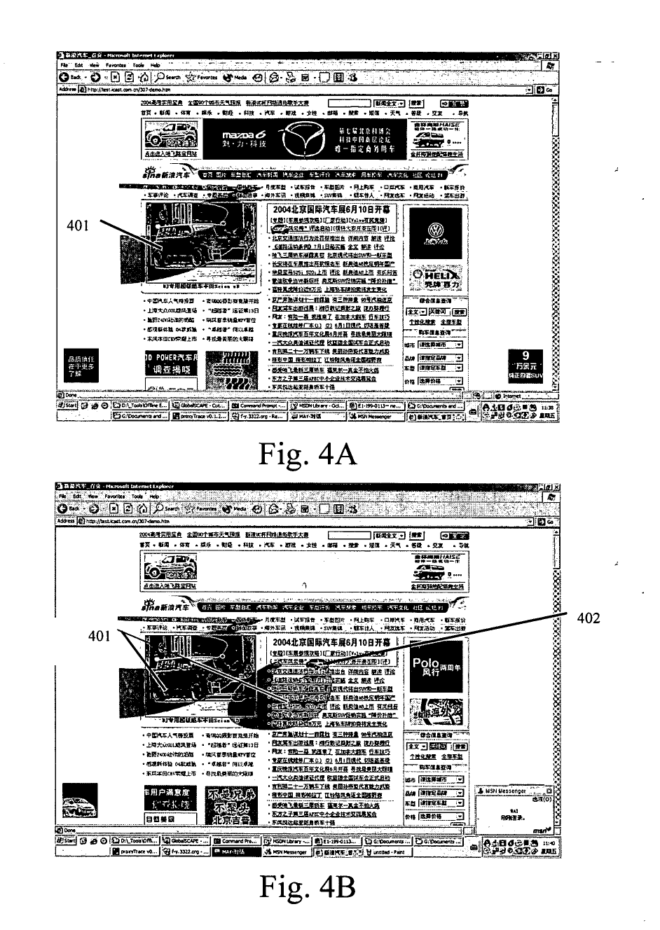

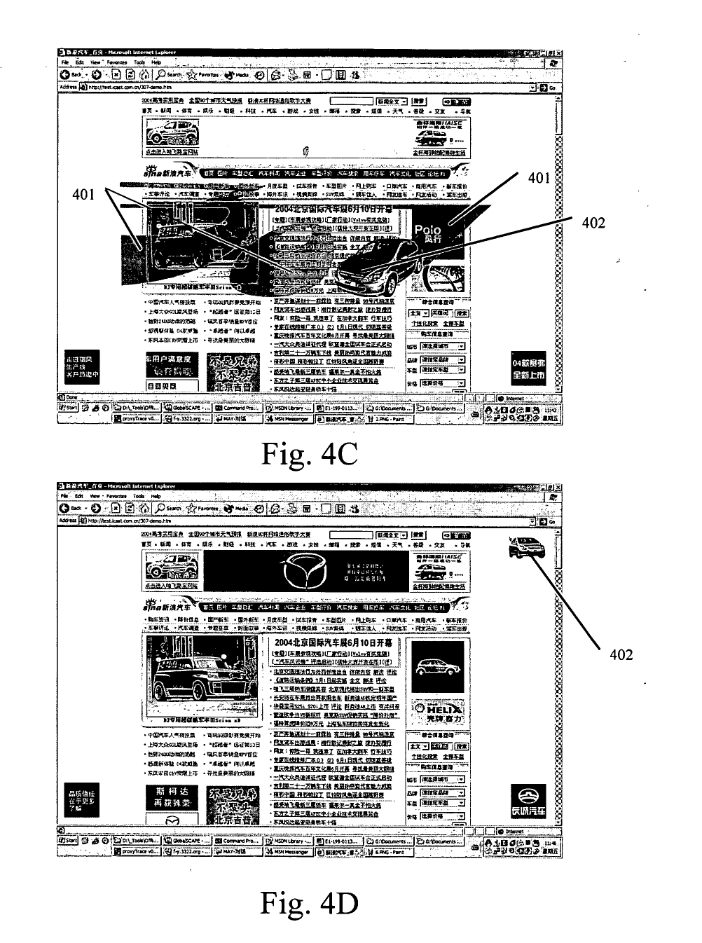

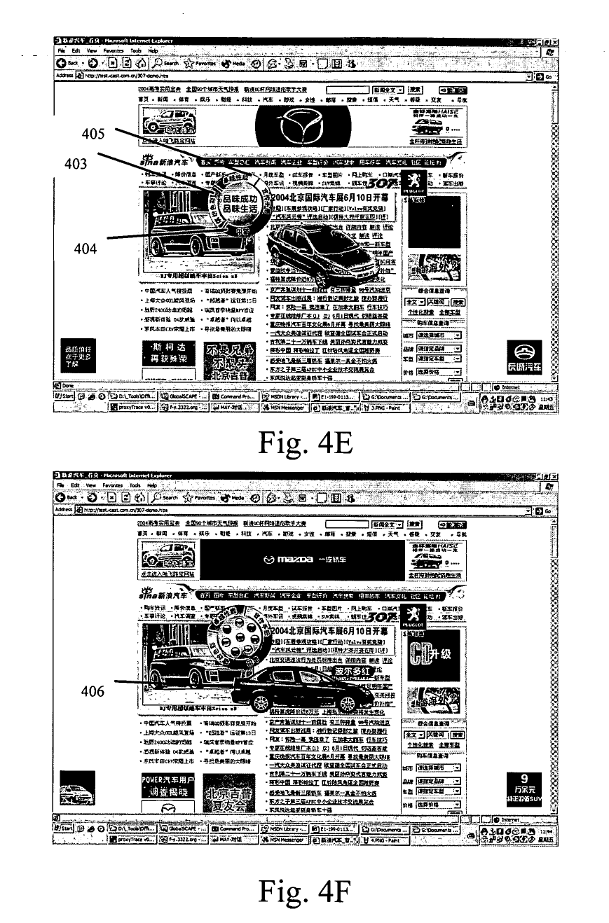

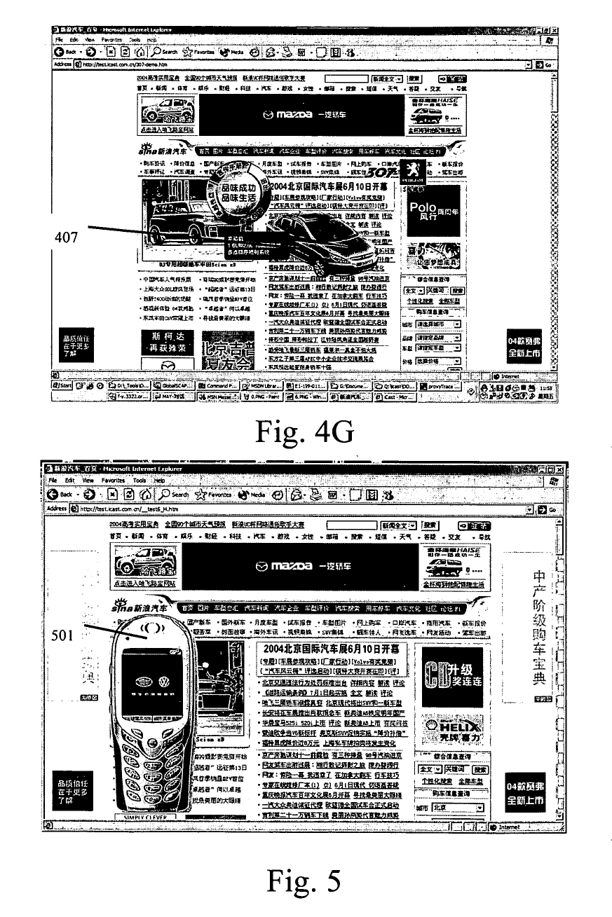

In the Internet advertisements of the present invention, multiple personality statistic items may be used. For example, after the Internet advertisement is played, “FSCommand (‘fullPlayed’)” may be executed. Also, if the advertiser hopes to take statistics on the times the “Change Color” is tried by the user in the automotive Internet advertisement as shown in FIG. 4E, FSCommand (‘select_color’) may be inserted in the area denoted by 403 in FIG. 4E. Any activities on which the advertiser hopes to take statistics may be collected in similar methods.

For more information about FSCommand, reference may be made to the development documents which are available from Macromedia Inc., or consult Macromedia flash support center via “http://www.macromedia.com/support/flash/”.

Providing Internet Advertisements

The following description is given to the apparatus for providing Internet advertisements, i.e. background intelligent downloading apparatus 19, and the method for providing Internet advertisements.

Background intelligent downloading apparatus 19 comprises means for downloading, in a manner substantially unnoticeable to a user who is browsing through a web page, an Internet advertisement into a cache of a browser, and a player for playing the downloaded Internet advertisement to the user after the Internet advertisement is completely downloaded.

When a user browses through a web page (i.e. a host web page) along with which an Internet advertisement is scheduled to be delivered, the Internet advertisement is downloaded to the user's computer. Here, the downloading of the Internet advertisement is substantially unnoticeable to the user, even though the size of the Internet advertisement might be several hundred bytes, for example 200K to 300K bytes. Only after the Internet advertisement is completely downloaded to the user's computer, does the player play the downloaded Internet advertisement to the user.

Two embodiments of background intelligent downloading apparatus 19 are given in the following.

The first embodiment of background intelligent downloading apparatus 19 is implemented as a piece of JavaScript codes which are embedded in the web page (i.e. the host web page) along with which the Internet advertisement is to be delivered. The first embodiment applies to the browsers that do not support Java applet. JavaScript codes may automatically determine whether the browser support Java applet or not.

In the first embodiment, background intelligent downloading apparatus 19 further comprises means for opening a separate window independent of the web page. For most browsers that support Java, the downloading is conducted by a Java virtual machine. In this way, the downloading speed can be controlled, and the user is not affected while browsing through web pages in other windows. For some browsers that do not support Java, a container is opened, and the Internet advertisements are downloaded in the separate window by the browser itself. Of course, in this way, the downloading speed cannot be controlled. The only thing that can be ensured is that the download is initiated only after all contents of the web page have been completely loaded so that the user will not be affected while viewing the web page. This separate window is either a window independent of the current web page or an element included in the current web page, such as a <DIV> tag, etc.

In the above first embodiment, the separate window may be any container for advertisement such as a dialog box, a popup window, a banner, a floating window (also known as a floating layer), an inline frame (IFRAME), etc. Different containers impose no restriction on the invention. Besides, the shapes, colors and styles of the player also impose no restriction on the invention.

FIG. 2 schematically shows the apparatus for providing Internet advertisements (i.e., background intelligent downloading apparatus 19) according to one embodiment of the present invention.

The second embodiment of background intelligent downloading apparatus 19 is implemented as a piece of JavaScript codes and a Java applet which are embedded in the web page (i.e. the host web page) along with which the Internet advertisement is to be delivered. As shown in FIG. 2, background intelligent downloading apparatus 19 comprises JavaScript module 1 and Java applet downloading module 2.

JavaScript module 1 is used to receive, from ad delivery engine 11 in FIG. 1, the file name (or URL, or ID) of the Internet advertisement to be delivered, and transfer the file name (or URL, or ID) of the Internet advertisement to be delivered to Java applet downloading module 2. After the Internet advertisement is completely downloaded to the cache of the browser by Java applet downloading module 2, JavaScript module 1 controls a player (browser) to play the downloaded Internet advertisement, records the user's activities in viewing the Internet advertisement, such as viewing to the end of the advertisement, switching to the advertised web site, etc., and submits the recorded data to data statistic engine 12 shown in FIG. 1. JavaScript module 1 also communicates with Java applet downloading module 2, so as to control the playing time of more than two Internet advertisements, to control the number of times each Internet advertisement is played.

Java applet downloading module 2 is used to dynamically monitor the speed of the network connection of the user's computer, intelligently control the downloading of the Internet advertisement into the cache of the browser (browser cache 21), manage the queue of advertisements that have not been completely downloaded, manage the queue of advertisements that have been completely downloaded, and provide a status flag indicating the completion when the downloading is finished.

Java applet downloading module 2 comprises:

means for downloading a first part of the Internet advertisement (e.g., a first predetermined number of bytes) into a browser cache;

means for calculating the downloading bandwidth;

means for identifying the current connection which is either a broadband connection or a narrowband connection;

means for downloading a following part of the Internet advertisement (a predetermined number of bytes, or for a predetermined period of time) in a way appropriate for the current connection.

Background intelligent downloading apparatus 19 may further comprises means for opening a separate window independent of the web page after the Internet advertisement is completely downloaded. The means for opening a separate window may be a part of JavaScript module 1 or a part of the browser. A player (browser) plays the Internet advertisement in the separate window after the Internet advertisement is completely downloaded.

In the above second embodiment, the separate window may be any container for advertisement such as a dialog box, a popup window, a banner, a floating window (also known as a floating layer), an inline frame, etc. Different containers impose no restriction on the invention. Besides, the shapes, colors and styles of the player also impose no restriction on the invention.

The means for identifying the current connection identifies the current connection as a broadband connection if the downloading bandwidth is greater than a broadband threshold, or identifies the current connection as a narrowband connection if the downloading bandwidth is less than a narrowband threshold.

The means for downloading a following part of the Internet advertisement downloads the Internet advertisement for a second predetermined period of time, say one second, if the current connection is identified as a broadband connection, downloads a predetermined number of bytes of the Internet advertisement if the current connection is identified as a narrowband connection, or suspends the downloading for a first predetermined period of time if the downloading bandwidth is less than an idle threshold for narrowband connection.

The following is an example of background intelligent downloading apparatus 19. It is implemented in a piece of JavaScript codes and a Java applet. The JavaScript codes and Java applet are embedded in the web page (i.e., host web page) along with which the Internet advertisement is to be delivered.

```
<!-icast Start-->
<script language=“javascript”>
var icast_channel_ID=57;
var _iCast_Controller_init=[
  icast_channel_ID, 42153,
  “http://ad4.sina.com.cn/bj-icast/mv/31/”,
  “http://ad4.sina.com.cn/forflash/flash/”,
  “42153.swf”,
  400, 300];
</script>
<script language=“javascript” src=
  “http://ad4.sina.com.cn/bj-icast/mv/31/icast.js”>
</script>
```

In the above example, the URL of the Internet advertisement to be delivered is “http://ad4.sina.com.cn/bj-icast/mv/31/42153.swf”. The file name of the Internet advertisement is “42153.swf”. The URL or file name of the Internet advertisement can be modified by ad delivery engine 11 shown in FIG. 1 in accordance with the Internet advertisement to be delivered. JavaScript program executed in the web page is “http://ad4.sina.com.cn/bj-icast/mv/31/icast.js”. The network path of Java applet downloading module 2 is “http://ad4.sina.com.cn/forflash/flash/”. When a web page (i.e. the host web page) including the above script codes is accessed by a browser, the Java applet will be downloaded into the user's computer, reside in the memory and run to function as background intelligent downloading apparatus 19.

Those skilled in the art should appreciate that the step of downloading a first part of Internet contents, the step of calculating the downloading bandwidth,- the step of identifying the current connection, and the step of downloading a following part of the Internet advertisement, which are implemented in a Java applet, may be implemented with any software components having similar functions (e.g., a new version of Flash), imposing no restriction on the present invention.

The method of providing Internet advertisements according to the present invention is described below. The method of providing Internet advertisements according to the present invention comprises the following steps of:

downloading the Internet advertisement in a manner substantially unnoticeable to a user who is browsing through a web page;

presenting (playing) the Internet advertisement to the user, after the Internet advertisement is completely downloaded.

Two embodiments of the method for providing Internet advertisements according to the present invention are described below.

The first embodiment of the method for providing Internet advertisement is implemented as a piece of JavaScript codes which are embedded in the web page (i.e., host web page) along with which the Internet advertisement is to be delivered.

In the first embodiment, the method of providing Internet advertisements further comprises the following steps of:

opening a separate window independent of the web page, wherein the Internet advertisement will be played in the separate window;

causing the separate window to emerge from behind all other windows after the Internet advertisement is completely downloaded; and

playing the Internet advertisement in the separate window.

In the above first embodiment, the separate window may be any container for advertisement such as a dialog box, a popup window, a banner, a floating window (also known as a floating layer), an inline frame, etc. Different containers impose no restriction on the invention.

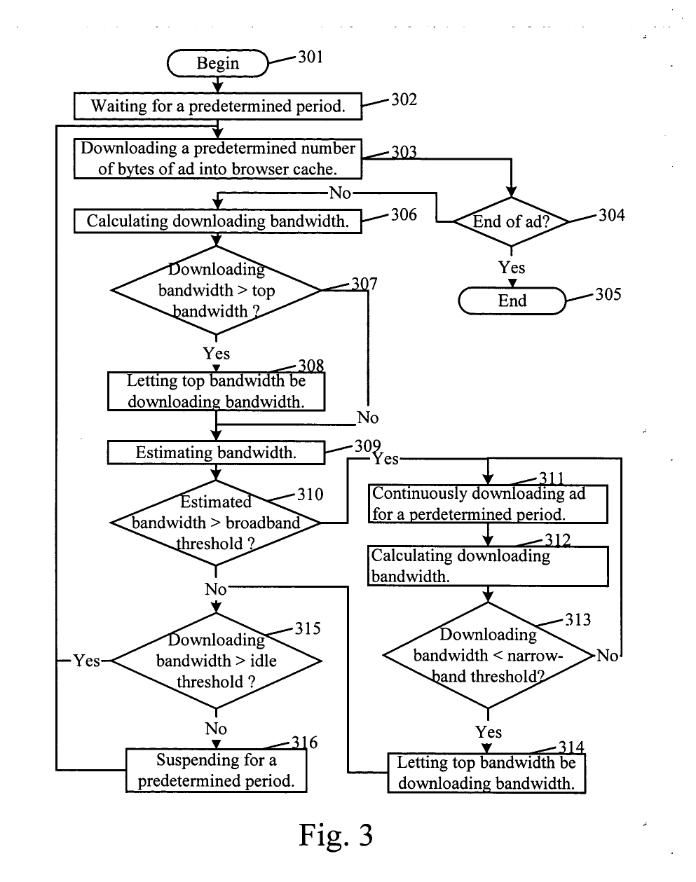

FIG. 3 is a flow chart of the method of providing Internet advertisements according to another embodiment of the present invention. The second embodiment of the method of providing Internet advertisements is implemented in a piece of JavaScript codes and a Java applet which are embedded in the web page (i.e. the host web page) along with which the Internet advertisement is to be delivered. FIG. 3 shows the main flow chart of the Java applet.

As shown in FIG. 3, the process begins at step 301. Then, at step 302, the process waits for a predetermined period of time, say five seconds, so that the whole web page may be completely loaded into the browser cache.

Next, at step 303, the process downloads a predetermined number of bytes of the Internet advertisement into the browser cache.

At step 304, it is decided whether the Internet advertisement has been completely downloaded. If the decision at step 304 is “yes”, the process goes to step 305; otherwise, to step 306.

At step 305, the downloading process ends. The control is then passed to JavaScript codes such that the downloaded Internet advertisement will be played.

At step 306, the downloading bandwidth is calculated.

At step 307, it is decided whether the downloading bandwidth is greater than the top bandwidth.

If the decision of step 307 is “no”, the process goes to step 309; otherwise, to step 308.

At step 308, the value of the downloading bandwidth is assigned to the top bandwidth.

At step 309, a bandwidth is estimated based on the calculated bandwidth. For example, if the calculated downloading bandwidth is 48 kbps, the estimated bandwidth may be 56 kbps.

At step 310, it is decided whether the estimated bandwidth is greater than a broadband threshold. If the decision of step 310 is “yes”, the process goes to step 311; otherwise, to step 315.

At step 311, the Internet advertisement is continuously downloaded for a predetermined period of time, say several milliseconds.

At step 312, the downloading bandwidth is calculated.

At step 313, it is decided whether the downloading bandwidth is less than a narrowband threshold. If the decision of step 313 is “no”, the process goes to step 311; otherwise, to step 314.

At step 314, the value of the downloading bandwidth is assigned to the top bandwidth. Then, the process goes to step 315.

At step 315, it is decided whether the downloading bandwidth is greater than the idle threshold for the narrowband connection.

If the decision of step 315 is “no”, which means the network is busy, the process goes to step 316; otherwise to step 303.

At step 316, the process is suspended for a predetermined period of time, such that the browsing speed of the user is not affected. Then the process goes to step 303.

As concluded from FIG. 3, the step of downloading the Internet advertisement comprises the following steps of:

downloading a first part of the Internet advertisement into a browser cache;

calculating a downloading bandwidth;

identifying current connection which is either a broadband connection or a narrowband connection;

downloading a following part of the Internet advertisement in a way appropriate for the speed of the current connection.

The steps of calculating a downloading bandwidth, identifying current connection, and downloading a following part of the Internet advertisement are repeated until the Internet advertisement is completely downloaded.

The method of providing Internet advertisements according to the present invention may further comprises the following steps of: opening a separate window independent of the web page, after the Internet advertisement is completely downloaded; and playing the Internet advertisement in the separate window.

In the above second embodiment, the separate window may be any container for advertisement such as a dialog box, a popup window, a banner, a floating window (also known as a floating layer), an inline frame, etc. Different containers impose no restriction on the invention.

Also concluded from FIG. 3 is that the step of identifying current connection comprises steps of:

identifying the current connection as a broadband connection if the downloading bandwidth is greater than a broadband threshold; and

identifying the current connection as a narrowband connection if the downloading bandwidth is less than a narrowband threshold.

The step of downloading a following part of the Internet advertisement comprises steps of:

downloading the Internet advertisement for a second predetermined period of time if the current connection is identified as a broadband connection; and

downloading a predetermined number of bytes of the Internet advertisement if the current connection is identified as a narrowband connection.

The step of downloading a predetermined number of bytes of the Internet advertisement is suspended for a first predetermined period of time, if the downloading bandwidth is less than an idle threshold.

Those skilled in the art may conceive many different methods. The above method of identifying the current connection imposes no restriction on the present invention.

Presenting (or Playing) Internet Advertisements

As described above, in order to play an Internet advertisement in a certain web page, it is necessary to insert, ad advance, the codes for the Internet advertisement to be played into the HTML codes for the web page. Here, the inserted codes are a piece of advertisement initialization code for loading the Internet advertisement, such as JavaScript module 1 in FIG. 2. In so doing, the published web page has the structure as shown in Table 2.

TABLE 2

The contents of the original web page
The advertisement initialization codes

For example, the published web page may contain the following HTML codes:

<Contents of the Original Web Page >
......
<script language=“javascript”>
var iCast_chennel_ID = 123;
</script>
<script language=“javascript”
src=“http://.../icast.js”>
</script>

In the above codes, the first portion of the codes is used to indicate what the web page is, and the second portion of the codes is used to call the real control codes.

The playing procedure of Internet advertisements is described below.

When the web page of the structure as shown in table 2 is opened, the second portion of the codes in the web page calls the real control codes “icast.js”. The JavaScript program in the control codes “icast.js” adds two new objects in the web page: (1) Internet advertisement container, and (2) Java applet intelligent downloading module. Then, the opened web page finally has the structure as shown in table 3.

TABLE 3

```
The contents of the original web page
Internet advertisement container
Java applet downloading module
JavaScript: Interface program for receiving
    messages sent by FSCommand in the
    Internet advertisement
JavaScript: other control codes
```

In the structure as shown in table 3, the Internet advertisement container is used to contain and locate the Internet advertisement (such as the published “.swf” file as stated above) to be played. In an embodiment of the present invention, the Internet advertisement container will create an Internet advertisement container, which is initially invisible.

Generally, the Internet advertisement container is created by such tags as <div> and <span> in HTML codes. The Internet advertisement container, for example, contains the following codes:

```
<Other Contents of the Web Page>
<div id=“iCast_Container”
    style=“position:absolute; visibility:hidden”>
    &nsbsp;
</div>
```

The id (identifier) attribute of tag <div> in the above codes is only a name for the tag, for JavaScript module 1 in the web page to refer to. The style attribute in the above codes indicates that this container is initially invisible (hidden). The container is located in a “absolute” manner. Therefore, the created Internet advertisement container does not affect the style or format of the original contents in the web page.

The Java applet downloading module having the structure as shown in table 3 has the functions that have been described with reference to FIGS. 2 and 3. This module is used to intelligently download the Internet advertisement of the present invention in background. The Java applet downloading module has two main interface functions. One interface function is used to inform the Java applet downloading module of which file should be downloaded. The other interface function is used to enquire whether the downloading of the file that should be downloaded has completed.

The exemplary codes for creating a Java applet downloading module is as follows:

```
<applet
  name=“iCast_APP”
  code=“com.icastxp.web.iCastXP.class”
  codebase=“http://<a-server>/<a-directory>/”
  archive=“iCastXP.jar”
  style=“visibility:hidden; position:absolute”
  width=1 height=1
  MAYSCRIPT>
  <param name=“flashurl”
      value=“http://a.com/b/c/d.swf”>
</applet>
```

The name attribute in the above codes defines the name of this Java applet downloading module object to be cited in the web page. The code, codebase (directory containing the codes) and archive (package) attributes are used to indicate the specific network position where the java applet downloading module can be retrieved. The style, width and height attributes define that this Java applet download module is an invisible object that does not affect the style or format of the normal contents. Parameter “flashurl” in <param> informs the Java applet downloading module of the position of the file (i.e., the Internet advertisement) to be downloaded. In this example, the Internet advertisement to be downloaded is “http://a.com/b/c/d.swf”.

After the java applet downloading module obtains, via a corresponding interface, the file name (or URL, or ID) of the Internet advertisement that needs to be downloaded, it starts to download the Internet advertisement. Before the downloading of the Internet advertisement is completed, the Internet advertisement playing procedure of the present invention is in a waiting state all the time. Please note that the waiting state does not affect the user's browsing through the host web page.

In order to enquire whether the downloading of the file to be downloaded is completed, the Java applet downloading module provides an interface function isAvailable( ), whose exemplary codes are shown as follows:

```
<script language=“JavaScript”>
  var obj=document.applets[“iCast_APP”];
  if (obj.isAvailable( )) {
  // Call codes for displaying the Internet
    advertisement
  }
  else {
  //delay, and enquire again
  }
</script>
```

In this embodiment, after the downloading of the Internet advertisement is completed, the following codes for displaying the “Flash” type file are inserted into the Internet container tag, which has been prepared as above:

<object
Classid=“clsid:D27CDB6E-AE6D-11cf-96B8-444553540000”
codebase=“http://download.macromedia.com/pub/shockwave/
cabs/flash/swflash.cab#version=5,0,0,0”
width=“400” height=“300” align=center>
<param name=movie value=“ad.swf”>
......
<param name=wmode value=transparent>
......
</object>

so as to obtain the following result:

<div id=“container” style=“position:absolute”;
left=100; top=50>
<!-display FLASH codes-->
<object
classid=“clsid:D27CDB6E-AE6D-11cf-96B8-44455354000
0”codebase=“http://download.macromedia.com/pub/shockwave/
cabs/flash/swflash.cab#version=5,0,0,0”
width=“400” height=“300” align=center>
<param name=movie value=“ad.swf”>
......
<param name=wmode value=transparent>
......
</object>
</div>

In the above codes, the parameter “value=transparent name=wmode” makes the “Flash” type file displayed in the web page have transparent surroundings.

Then, the Internet advertisement container tag is made visible, and the Internet advertisement container is located to the desired position in the web page, and the “Flash” type file that has been completely downloaded is played in the Internet advertisement container. Consequently, the user may watch the Internet advertisement delivered along with the web page.

FIG. 4A to FIG. 4G show the effects of displaying an exemplified automotive Internet advertisement according to one embodiment of the present invention. The web page in the background of FIG. 4A to FIG. 4G is the host web page for the Internet advertisement of the present invention, i.e., the web page along with which the Internet advertisement of the present invention is delivered. Reference number 401 in FIG. 4A, FIG. 4B and FIG. 4C denotes the trace of the car running across the host web page, and 402 the car. Such an object that is in any shape, has transparent surroundings and moves on the host web page can greatly attract the user's attention, and achieve good advertising effects.

After the playing of the Internet advertisement is finished, or the user closes (for example by clicking the “Cancel” button denoted by 404 in FIG. 4E) the advertisement on his/her own initiative, the Internet advertisement container is once again made invisible so that the layer is hidden. This may be implemented in JavaScript “container.style. visibility=‘hidden’”. After the Internet advertisement container is made invisible, the display of the host web page resumes to the original state as if the Internet advertisement had never been displayed. Alternatively, after the playing of the advertisement is finished, or while the advertisement is being played, the Internet advertisement is scaled down to an icon as denoted by 402 in FIG. 4D, either directly or upon selection by the user

While the Internet advertisement is being played, the viewer may perform such control operations as replay, pause, volume adjustment with respect to the Internet advertisement that is being played. These control operations are processed by the advertisement play control codes included in the Internet advertisement that is being played. Here, the advertisement play control codes are those that have been inserted into the “Flash” type source file while the Internet advertisement is produced, as shown table 1.

The viewer may also operate on many interactive contents of the Internet advertisement, such as changing product color, rolling product angle, playing small games designed for the advertisement, etc. These activities may be sent to the corresponding interface program included in the web page, in the FSCommand manner described above, by the personality statistic codes included in the Internet advertisement (see table 1). After these messages are received by the interface program, the interface program performs necessary process, and then forwards these messages to the codes in the JavaScript module that are responsible for submitting data (see table 3, the structure shown in this table includes a JavaScript interface program that is used to receive messages sent via FSCommand in the Internet advertisement). Finally the user activities are submitted to data statistic engine 12.

For example, if a viewer clicks the “Multiple Colors” button denoted by 403 in FIG. 4E, cars 406 of different colors may be displayed in FIG. 4F. If the viewer clicks the “Excellent Performance” button denoted by 405 in FIG. 4E, various indexes of performance of car 407 may be displayed in FIG. 4G.

FIG. 5 shows the effects of displaying an exemplified mobile phone Internet advertisement according to one embodiment of the present invention. FIG. 5 shows that mobile phone 501 is slowly emerging to one corner of the web page. In order to further attract the user's attention, even video may be displayed on the screen of mobile phone 501.

The Java applet mentioned in the above description is a kind of program written for Internet browsers in Sun Microsystems, Inc.'s Java programming language. Java applets can accomplish stronger program functions. JavaScript is a script language invented by Netscape Communications Corp. and used in web pages, which provides efficiency for controlling dynamic contents in the web pages. “Flash” type file is a multimedia file format proposed by Macromedia Inc., and mainly used for displaying animation. The “Flash” type file players are widely installed in various browsers.

While the foregoing has been with reference to specific embodiments of the invention, it will be appreciated by those skilled in the art that these are illustrations only and that changes in these embodiments can be made without departing from the principles of the invention, the scope of which is defined by the appended claims.

1. A method of providing Internet contents, comprising steps of:
downloading said Internet contents in a manner substantially unnoticeable to a user who browses a web page;
presenting, in a container, said Internet contents to said user, after said Internet contents are completely downloaded.

2. The method according to claim 1, wherein said container is independent of said web page, and said container emerges from behind said web page after said Internet contents are completely downloaded.

3. The method according to claim 1, wherein said container is created using a tag included in said web page.

4. The method according to claim 1, wherein said container is selected from a group consisting of a dialog box, a popup window, a banner, a floating layer, and an inline frame.

5. The method according to claim 4, wherein said container is a transparent floating layer, and said Internet contents are contents in any shape and with transparent surroundings.

6. The method according to claim 1, wherein
said step of downloading Internet contents is performed by a Java virtual machine of a browser if said browser supports Java;
said step of downloading Internet contents is performed by a browser itself if said browser does not support Java.

7. The method according to claim 1, wherein said step of downloading Internet contents comprises steps of:
downloading a first part of said Internet contents into a browser cache;
calculating downloading bandwidth;
identifying current connection which is either a broadband connection or a narrowband connection;
downloading a following part of said Internet contents in a way appropriate for said current connection.

8. The method according to claim 7, wherein said steps of calculating downloading bandwidth, identifying current connection, and downloading a following part of said Internet contents are repeated until said Internet contents are completely downloaded.

9. The method according to claim 8, wherein said step of identifying current connection comprises steps of:
identifying said current connection as a broadband connection, if said downloading bandwidth is greater than a broadband threshold; and
identifying said current connection as a narrowband connection, if said downloading bandwidth is less than a narrowband threshold.

10. The method according to claim 8, wherein said step of downloading a following part of said Internet contents comprises steps of:
downloading said Internet contents for a second predetermined period of time if said current connection is identified as a broadband connection; and
downloading a predetermined number of bytes of said Internet contents if said current connection is identified as a narrowband connection.

11. The method according to claim 10, wherein said step of downloading a predetermined number of bytes of said Internet contents is suspended for a first predetermined period of time, if said downloading bandwidth is less than an idle threshold.

12. The method according to claim 8, wherein said steps of downloading a first part of said Internet contents, calculating downloading bandwidth, identifying current connection, and downloading a following part of said Internet contents are implemented in Java applet.

13. A method of providing Internet contents, comprising steps of:
inserting into a host web page of said Internet contents a tag used for creating an initially invisible container for Internet contents;
downloading said Internet contents in a manner substantially unnoticeable to a user;
inserting into said tag codes for displaying said Internet contents with surroundings being transparent, after said Internet contents are completely downloaded;
setting said tag to be visible; and
presenting said Internet contents in a container for Internet contents created using said tag.

14. The method according to claim 13, wherein said step of downloading said Internet contents comprises steps of:
downloading a first part of said Internet contents into a browser cache;
calculating downloading bandwidth;
identifying current connection which is either a broadband connection or a narrowband connection;
downloading a following part of said Internet contents in a way appropriate for said current connection.

15. An apparatus for providing Internet contents, comprising:
means for downloading Internet contents in a manner substantially unnoticeable to a user who browses a web page;
means for presenting said Internet contents to said user in a container after said Internet contents are completely downloaded.

16. The apparatus according to claim 15, further comprising:
means for creating said container;
wherein a browser downloads said Internet contents in said container, and said container emerges from behind said web page after said Internet contents are completely downloaded.

17. The apparatus according to claim 15, further comprising:
means for creating said container based on a tag included in said web page.

18. The apparatus according to claim 15, wherein said means for downloading Internet contents is a Java virtual machine.

19. The apparatus according to claim 15, wherein said means for downloading Internet contents comprises:
means for downloading a first part of said Internet contents into a browser cache;
means for calculating downloading bandwidth;
means for identifying current connection which is either a broadband connection or a narrowband connection;
means for downloading a following part of said Internet contents in a way appropriate for said current connection.

20. The apparatus according to claim 15, wherein said container is selected from a group consisting of a dialog box, a popup window, a banner, a floating layer, and an inline frame.
